(19) United States
(12) Patent Application Publication
(10) Pub. No.: US 2007/0102387 A1
(43) Pub. Date: May 10, 2007

(54) Method for operating a crane with multicable drive

(76) Inventor: Rudiger Zollondz, Hornbach (DE)

Correspondence Address: LEWIS F. GOULD, JR.;DUANE MORRIS LLP, 30 SOUTH 17TH STREET, PHILADELPHIA, PA, 19103, US

(21) Appl. No.: 11/582,796

(22) Filed: Oct. 18, 2006

(30) Foreign Application Priority Data
Oct. 18, 2005 (DE) 10 2005 050 699.2

(51) Int. Cl. B66C 23/06

(52) U.S. Cl. 212/232

(57) ABSTRACT

The present invention is a method for operating a crane with multicable drive that is characterized in that the path covered by each of the individual cable drives is detected and the paths are synchronized.

### BACKGROUND OF THE INVENTION

The present invention pertains to a method for operating a crane with multicable drive.

### BRIEF SUMMARY OF THE INVENTION

Up-and-down hoisting units operated on cranes consist, for reasons of synchronization, of identical winches, which accommodate cables having identical diameters and identical cable length.

For this reason, the drives of the hoisting units likewise have an identical design.

A mixed use of different winches and different cable diameters together in a crane was not possible up to now or has not become known.

The hoisting cables are usually guided from the upper carrying chassis of the crane directly to the jib head or, if a superlift system is used, guided via the superlift boom to the jib head.

It is common in up-and-down hoisting units to guide both hoisting cables to the bottom hook block on identical or almost identical paths.

### DETAILED DESCRIPTION OF THE INVENTION

The basic object of the present invention is to improve the mode of operation and use possibilities in a crane with multicable drive and to lower the operating costs.

This object is accomplished according to the present invention by a method for operating a crane with multicable drive, in which the path covered by each of the individual cable drives is detected and the paths are synchronized.

This can happen in that the path covered by each cable drive is detected and the paths are synchronized by changing the speed of the winches.

Moreover, it is advantageous when the path covered by the cable drive is indicated and, in addition, the remaining cable length on each of the winches is indicated.

Thus, in the crane, for example, with double cable drive, two winches are provided, which have different geometries and/or can accommodate cables of different diameters and operate in double bottom hook block operation, whereby the cables are guided on the same or different paths and whereby the speed of the drives of the winches can be controlled.

Advantageously hereby, the winches are provided with angle of rotation sensors.

A number of considerable advantages arise from this mode of operation or this crane design.

Thus, different sets of winches can be used on various cranes without changing the winches. On the one hand, this results in considerable cost advantages, particularly because winches can be replaced/exchanged with one another without any problem. Furthermore, if a hoisting cable is damaged, it no longer has to be replaced, since the two hoisting cables no longer have to have the absolutely same length.

A double or multicable drive, composed of two or more nonidentical cable drives, is synchronized according to the present invention so that the path at the end of the cable drive is equated. So-called absolute angle transmitters are used according to the present invention to detect the unwound cable lengths in each case. According to the present invention, a synchronization of winches of different geometries or different cable lengths takes place in the hoisting unit of a crane.

Winches of different geometries and cables of different diameters can be used with one another in a so-called double bottom hook block operation by means of selecting suitable measuring techniques on the winches and/or the cable rolls on the jib head and the direct input of these control variables into the hoisting unit control.

The reeving in the hoisting units (in the cable drive) does not have to be identical any longer. The cable length does not have to be identical any longer, either.

In comparison to prior-art solutions, a crane can be operated with one less winch without restricting its function. The investment volume is reduced by several percent.

The present invention shall be explained below in an exemplary embodiment, and, to be precise, in the example of a Terex-Demag lattice boom crane CC 2400-1, in which two hoisting cables having different lengths with different cable diameters are synchronized for a double bottom hook block operation. The course of the cables as well as the positioning of the individual winches can be freely selected and arranged in a wide range, e.g., an axially symmetrical or parallel arrangement is no longer absolutely necessary.

The figures show different embodiments, which are explained in detail.

Double hoisting units (4a, 4b) operated on cranes usually consist, for reasons of synchronization, of identical winches (FIG. 2), which accommodate cables having identical diameters and identical cable length.

The drives of the hoisting units likewise have an identical design for this reason.

The hoisting cables are usually guided from the upper carrying chassis (2) of the crane directly to the jib head (8), or if a superlift system is used, guided via the superlift boom (7) to the jib head (8).

It is common in up-and-down hoisting units to guide both hoisting cables to the bottom hook block (6) on identical or almost identical paths (FIG. 2, FIG. 4).

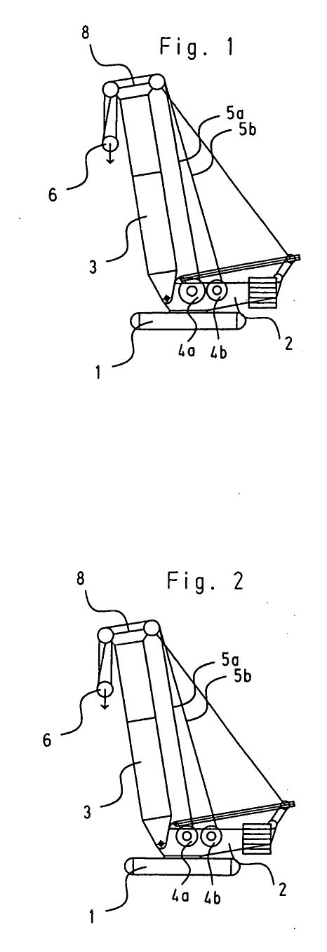

FIG. 1 now shows an embodiment with different winches 4a, 4b in the upper carrying chassis 2, or with identical winches 4a, 4b in the upper carrying chassis 2 (FIG. 2).

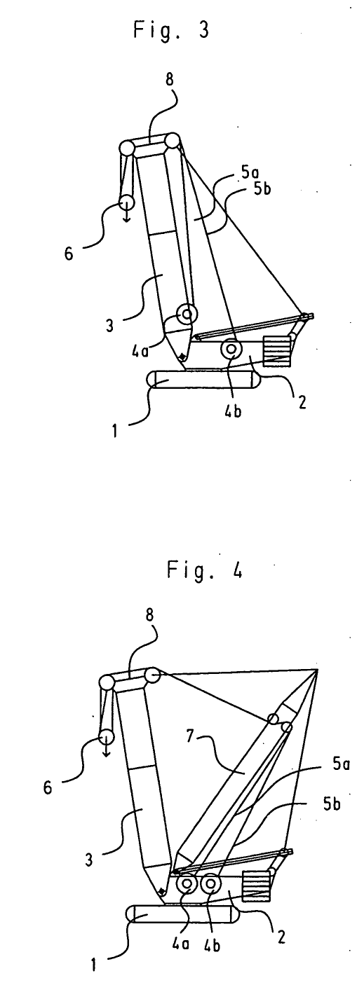

In the embodiment according to FIG. 3, two identical winches 4a, 4b are provided, one being installed in the upper carrying chassis 2 and one in the jib 3.

FIG. 4 shows a superlift operation, with a cable guiding via a superlift boom 7 and two identical winches 4a, 4b in the upper carrying chassis 2.

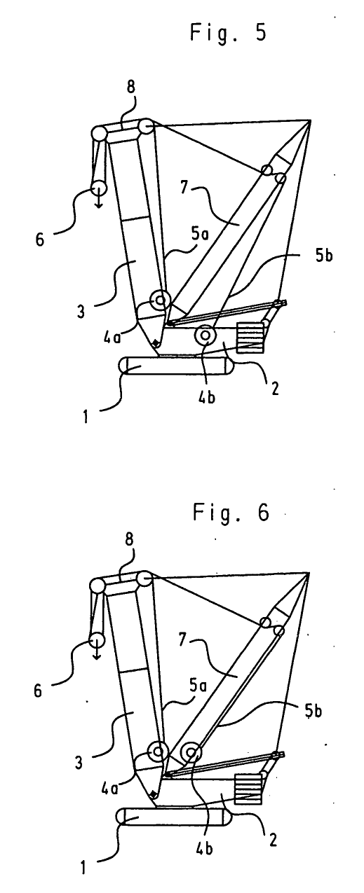

FIG. 5 shows the arrangement of the winches 4a, 4b, and, namely, identical winches, one being installed in the upper carrying chassis 2 and one in the jib 3.

Finally, FIG. 6 shows an embodiment, in which one winch 4a is accommodated in the jib 3 and one winch 4b is accommodated in the superlift boom 7.

Both in the view according to FIG. 5 and according to FIG. 6, the cable guides are different.

In summary, a crane with double cable drive results in the following: a double cable drive can take place even when the cable lengths are not sufficient; two small winches are less expensive than a large ones two small winches are easier to manipulate and transport; the double cable drive is synchronized, so that the double bottom hook block is not slanted; higher safety due to double cable drive; cables of the double cable drive run on the same paths to the jib head; cables of the double cable drive run via the superlift boom to the jib head in case of superlift operation; double cable drive, with winches next to one another; double cable drive, with winches arranged one behind the other in physical proximity; and double cable drive, with winches at different places in the crane (upper carrying chassis, jib, superlift boom).

1. Method for operating a crane with multicable drive, wherein the path covered by each of the individual cable drives is detected and the paths are synchronized.

2. Method of claim 1, wherein the path covered by each cable drive is detected and the paths are synchronized by a change in the speed of the winches.

3. Method of claim 1, wherein the path covered by the cable drive is indicated.

4. Method in of claim 1, wherein the cable length remaining on each of the winches is indicated.

5. Crane with multicable drive, wherein a plurality of winches are provided, which have different geometries and/or are able to accommodate cables of different diameters and operate in double bottom hook block operation, the cables being guided on the same or different paths and the speed of the drives of the winches being able to be controlled.

6. Crane of claim 5, wherein the winches are provided with angle of rotation sensors.

7. Method of claim 2, wherein the path covered by the cable drive is indicated.

8. Method of claim 2, wherein the cable length remaining on each of the winches is indicated.

9. Method of claim 3, wherein the cable length remaining on each of the winches is indicated.
